(19) United States
(12) Patent Application Publication
(10) Pub. No.: US 2025/0323325 A1
(43) Pub. Date: Oct. 16, 2025

(54) ELECTRICITY STORAGE CELL AND METHOD OF MANUFACTURING ELECTRODE ASSEMBLY

(71) Applicant: TOYOTA JIDOSHA KABUSHIKI KAISHA, Toyota-shi (JP)

(72) Inventors: Masato Ono, Nagoya-shi (JP); Masahiro Ishizuka, Toyota-shi (JP); Atsushi Sugihara, Toyota-shi (JP); Yuka Yokoi, Nagoya-shi (JP); Keitaro Machida, Hamamatsu-shi (JP); Ryosuke Sato, Toyota-shi (JP); Tatsuya Yamamoto, Toyohashi-shi (JP)

(73) Assignee: TOYOTA JIDOSHA KABUSHIKI KAISHA, Toyota-shi (JP)

(21) Appl. No.: 19/078,905

(22) Filed: Mar. 13, 2025

(30) Foreign Application Priority Data
Apr. 12, 2024 (JP) 2024-064695

(51) Int. Cl. H01M 10/0587; H01M 50/103

(52) U.S. Cl. CPC H01M 10/0587; H01M 50/103

(57) ABSTRACT

An electricity storage cell includes: an electrode assembly configured of a wound assembly including a positive electrode sheet and a negative electrode sheet that are wound through intermediation of a separator; and a cell case that accommodates the electrode assembly. The positive electrode sheet includes a positive electrode current collector, an inner positive electrode active material layer, and an outer positive electrode active material layer. The negative electrode sheet includes a negative electrode current collector, an inner negative electrode active material layer, and an outer negative electrode active material layer. The cell case is formed in a cuboid shape. The electrode assembly includes four corner portions. The positive electrode current collector at the corner portion includes a positive electrode exposed portion. The negative electrode current collector at the corner portion includes only a negative electrode covered portion.

### CROSS-REFERENCE TO RELATED APPLICATION

This application claims priority to Japanese Patent Application No. 2024-064695 filed on Apr. 12, 2024, incorporated herein by reference in its entirety.

### BACKGROUND

### 1. Technical Field

The present disclosure relates to an electricity storage cell and a method of manufacturing an electrode assembly.

### 2. Description of Related Art

For example, Japanese Unexamined Patent Application Publication No. 2023-47012 (JP 2023-47012 A) discloses a secondary battery including a wound electrode assembly and a rectangular battery case that accommodates the wound electrode assembly. The wound electrode assembly is configured by winding a positive electrode sheet and a negative electrode sheet through intermediation of a separator. The positive electrode sheet includes a positive electrode current collector, and a positive electrode active material layer formed on the positive electrode current collector. The negative electrode sheet includes a negative electrode current collector, and a negative electrode active material layer formed on the negative electrode current collector.

The wound electrode assembly is wound so that its shape as viewed from an axial direction of the wound electrode assembly becomes a rectangular shape. The wound electrode assembly includes corner portions positioned at four corners of the wound electrode assembly as viewed from the winding axial direction. At the corner portions of the positive electrode active material layer and the corner portions of the negative electrode active material layer, folding grooves are formed along the winding axial direction.

The folding grooves include an inner positive electrode folding groove formed in an inner positive electrode active material layer, an outer positive electrode folding groove formed in an outer positive electrode active material layer, an inner negative electrode folding groove formed in an inner negative electrode active material layer, and an outer negative electrode folding groove formed in an outer negative electrode active material layer.

### SUMMARY

In the secondary battery described in JP 2023-47012 A, a dead space between the wound electrode assembly and the battery case is reduced to improve the energy density. However, in this secondary battery, lithium ions may precipitate onto the negative electrode sheet at the time of charging.

The present disclosure has an object to provide an electricity storage cell and a method of manufacturing an electrode assembly that are capable of achieving both of improvement of an energy density and reduction of precipitation of lithium ions onto a negative electrode sheet.

An electricity storage cell according to one aspect of the present disclosure includes: an electrode assembly configured of a wound assembly including a positive electrode sheet and a negative electrode sheet that are wound through intermediation of a separator; and a cell case that accommodates the electrode assembly. The positive electrode sheet includes: a positive electrode current collector; an inner positive electrode active material layer provided on an inner surface of the positive electrode current collector in a radial direction of the wound assembly; and an outer positive electrode active material layer provided on an outer surface of the positive electrode current collector in the radial direction. The negative electrode sheet includes: a negative electrode current collector; an inner negative electrode active material layer formed on an inner surface of the negative electrode current collector in the radial direction; and an outer negative electrode active material layer formed on an outer surface of the negative electrode current collector in the radial direction. The cell case is formed in a cuboid shape. The electrode assembly includes four corner portions at the time of viewing the electrode assembly in an axial direction of the wound assembly. The positive electrode current collector at each of the corner portions includes a positive electrode exposed portion not provided with the inner positive electrode active material layer and the outer positive electrode active material layer. The negative electrode current collector at each of the corner portions includes only a negative electrode covered portion covered with the inner negative electrode active material layer and the outer negative electrode active material layer.

A method of manufacturing an electrode assembly in an electricity storage cell according to one aspect of the present disclosure includes: preparing a positive electrode sheet including a positive electrode current collector, an inner positive electrode active material layer provided on a surface on one side of the positive electrode current collector, and an outer positive electrode active material layer provided on a surface on the other side of the positive electrode current collector; preparing a negative electrode sheet including a negative electrode current collector, an inner negative electrode active material layer provided on a surface on one side of the negative electrode current collector, and an outer negative electrode active material layer provided on a surface on the other side of the negative electrode current collector; and winding the positive electrode sheet and the negative electrode sheet through intermediation of a separator to form the electrode assembly configured of a wound assembly. The preparing of the positive electrode sheet includes providing the inner positive electrode active material layer and the outer positive electrode active material layer by intermittent coating on the surface on the one side and the surface on the other side of the positive electrode current collector so as to form a positive electrode exposed portion not provided with the inner positive electrode active material layer and the outer positive electrode active material layer. The preparing of the negative electrode sheet includes providing the inner negative electrode active material layer and the outer negative electrode active material layer by continuous coating on the surface on the one side and the surface on the other side of the negative electrode current collector. The winding includes winding the positive electrode sheet, the negative electrode sheet, and the separator so as to position the positive electrode exposed portion at each of four corners at the time of viewing the wound assembly in an axial direction of the wound assembly.

According to the present disclosure, it is possible to provide the electricity storage cell and the method of manufacturing an electrode assembly that are capable of achieving both of the improvement of the energy density and the reduction of the precipitation of the lithium ions onto the negative electrode sheet.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view schematically illustrating an electricity storage cell according to one embodiment of the present disclosure;

FIG. 2 is a front view of the electricity storage cell;

FIG. 3 is a sectional view taken along the line III-III of FIG. 2;

FIG. 4 is a sectional view schematically illustrating a corner portion of a cell unit; and

FIG. 5 is a plan view of a state in which a positive electrode sheet and a negative electrode sheet are developed.

### DETAILED DESCRIPTION OF EMBODIMENTS

An embodiment of the present disclosure is described with reference to the drawings. It is to be noted that, in the drawings to be referred to below, like or corresponding members are denoted by like reference symbols.

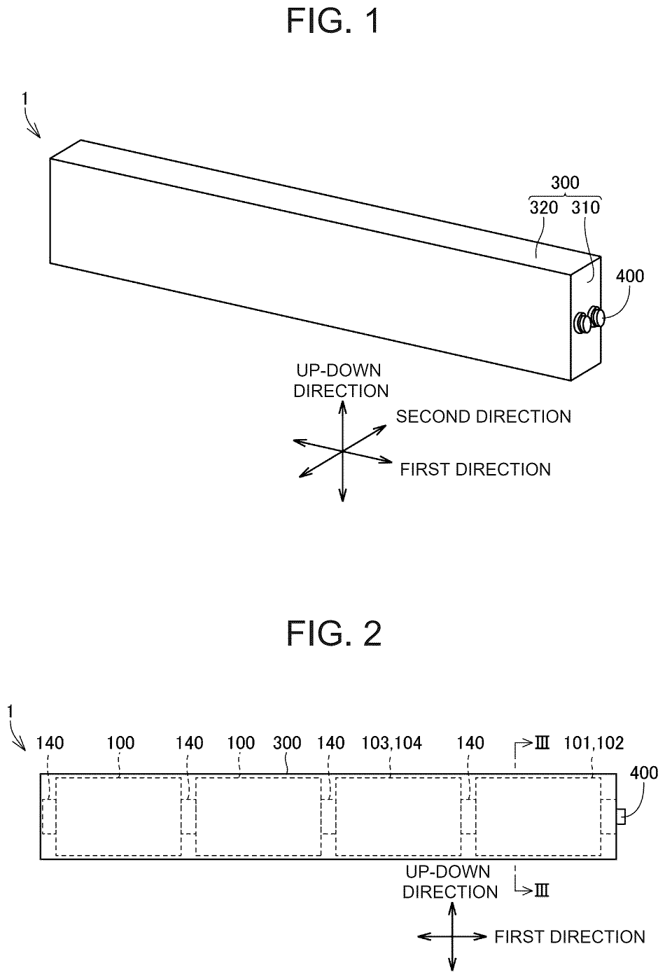

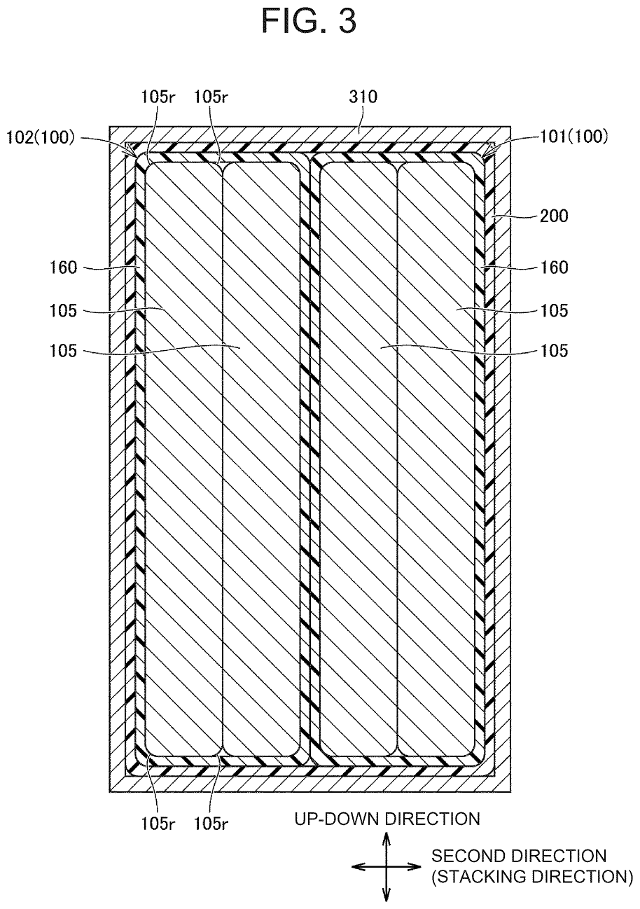

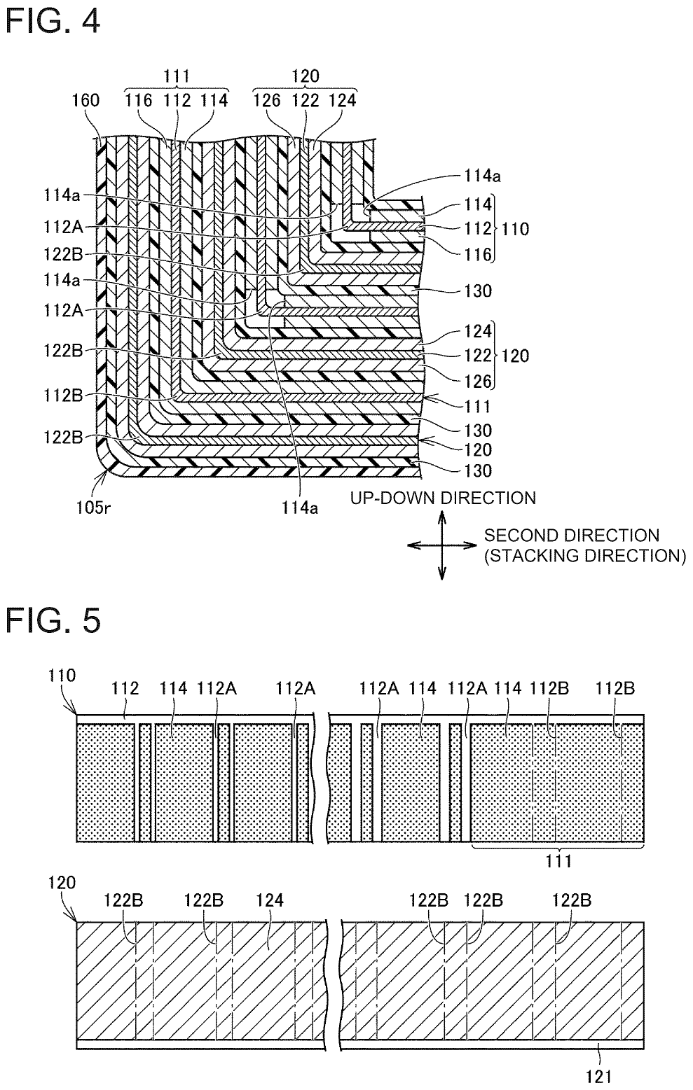

FIG. 1 is a perspective view schematically illustrating an electricity storage cell according to one embodiment of the present disclosure. FIG. 2 is a front view of the electricity storage cell. FIG. 3 is a sectional view taken along the line III-III of FIG. 2. FIG. 4 is a sectional view schematically illustrating a corner portion of a cell unit. An electricity storage cell 1 is mounted on, for example, a bottom portion of a vehicle.

As illustrated in FIG. 1 to FIG. 4, the electricity storage cell 1 includes a plurality of cell units 100, a covering sheet 200, a cell case 300, and an external terminal 400.

As illustrated in FIG. 2, the cell units 100 include a first cell unit 101, a second cell unit 102, a third cell unit 103, and a fourth cell unit 104. In this embodiment, the cell units 100 include eight cell units 100. However, the number of the cell units 100 is not limited to eight. Examples of each cell unit 100 include a lithium ion battery. Each cell unit 100 may be configured of what is called an all-solid-state battery including a solid electrolyte.

The first cell unit 101 is connected to the third cell unit 103. The second cell unit 102 is connected to the fourth cell unit 104. The first cell unit 101 and the second cell unit 102 are adjacent to each other in a second direction (a direction orthogonal to the drawing sheet of FIG. 2) orthogonal to both of a first direction and an up-down direction in which the first cell unit 101 and the third cell unit 103 are arranged. The third cell unit 103 and the fourth cell unit 104 are adjacent to each other in the second direction. Each cell unit 100 has a shape that extends longer in the first direction than in the second direction and extends longer in the first direction than in the up-down direction. Each cell unit 100 has a shape that extends longer in the up-down direction than in the second direction.

As illustrated in FIG. 2 and FIG. 3, each cell unit 100 includes at least one electrode assembly 105, a current collector terminal 140, and a laminate outer casing 160.

As illustrated in FIG. 3, the at least one electrode assembly 105 includes two electrode assemblies 105. However, the number of the electrode assemblies 105 is not limited to two. As illustrated in FIG. 4, each electrode assembly 105 is configured of a wound assembly obtained by winding a positive electrode sheet 110 and a negative electrode sheet 120 through intermediation of a separator 130. The two electrode assemblies 105 are adjacent to each other in a stacking direction in which the positive electrode sheet 110 and the negative electrode sheet 120 are stacked on each other. Each electrode assembly 105 is formed in a shape that is long in an orthogonal direction (an axial direction of the wound assembly) orthogonal to both of the stacking direction and the up-down direction. The stacking direction (a thickness direction) corresponds to the second direction, and the orthogonal direction (the axial direction of the wound assembly) corresponds to the first direction.

The current collector terminal 140 is connected to the electrode assembly 105. The current collector terminal 140 protrudes from the electrode assembly 105 in the first direction. The current collector terminal 140 electrically connected to the positive electrode sheet 110 in the electrode assembly 105 is made of, for example, aluminum. The current collector terminal 140 electrically connected to the negative electrode sheet 120 in the electrode assembly 105 is made of, for example, copper. The current collector terminal 140 is formed in a flat plate shape.

The laminate outer casing 160 accommodates the two electrode assemblies 105. The laminate outer casing 160 is made of a laminated film. The current collector terminal 140 protrudes from an edge portion of the laminate outer casing 160 in the first direction.

The covering sheet 200 covers the cell units 100. More specifically, the covering sheet 200 covers the cell units 100 so as to collectively surround the cell units 100. The covering sheet 200 is made of an insulating material (such as synthetic resin). It is to be noted that the covering sheet 200 may be omitted.

The cell case 300 accommodates the cell units 100. The cell case 300 is made of, for example, aluminum. The cell case 300 is formed in a cuboid shape. Each cell unit 100 is accommodated in the cell case 300 in such a posture that the center axis of the electrode assembly 105 is in parallel with the first direction. As illustrated in FIG. 1 to FIG. 3, the cell case 300 includes a case main body 310 and a lid 320.

The case main body 310 is formed in a rectangular tube shape that is opened in the first direction. The case main body 310 extends long in the first direction. The case main body 310 surrounds the cell units 100 and the covering sheet 200.

The lid 320 is connected to the case main body 310 by welding or the like so as to close the opening of the case main body 310.

The external terminal 400 is provided on the lid 320. The external terminal 400 is connected to the current collector terminal 140 of the cell unit 100 disposed at a position closest to the lid 320 out of the cell units 100.

Here, the electrode assembly 105 is described in detail. As illustrated in FIG. 3 and FIG. 4, cach electrode assembly 105 includes four corner portions 105r when the electrode assembly 105 is viewed in an axial direction of the wound assembly.

As illustrated in FIG. 4, the positive electrode sheet 110 includes a positive electrode current collector 112, an inner positive electrode active material layer 114, and an outer positive electrode active material layer 116. The positive electrode current collector 112 is made of metal such as aluminum. The inner positive electrode active material layer 114 is provided on an inner surface of the positive electrode current collector 112 in a radial direction of the wound assembly. The outer positive electrode active material layer 116 is provided on an outer surface of the positive electrode current collector 112 in the radial direction. The positive electrode sheet 110 includes an outermost positive electrode sheet portion 111 disposed on an outermost periphery of the wound assembly.

The negative electrode sheet 120 includes a negative electrode current collector 122, an inner negative electrode active material layer 124, and an outer negative electrode active material layer 126. The negative electrode current collector 122 is made of metal such as copper. The inner negative electrode active material layer 124 is provided on an inner surface of the negative electrode current collector 122 in the radial direction. The outer negative electrode active material layer 126 is provided on an outer surface of the negative electrode current collector 122 in the radial direction.

As illustrated in FIG. 4, the positive electrode current collector 112 includes a positive electrode exposed portion 112A and a positive electrode covered portion 112B. The positive electrode exposed portion 112A and the positive electrode covered portion 112B are both formed at the corner portion 105r.

The positive electrode exposed portion 112A is a portion of the positive electrode current collector 112 not provided with the inner positive electrode active material layer 114 and the outer positive electrode active material layer 116. That is, in the positive electrode exposed portion 112A, the positive electrode current collector 112 is exposed.

The positive electrode covered portion 112B is a portion of the positive electrode current collector 112 provided with the inner positive electrode active material layer 114 and the outer positive electrode active material layer 116. That is, the positive electrode covered portion 112B is covered with the inner positive electrode active material layer 114 and the outer positive electrode active material layer 116.

The positive electrode covered portion 112B is formed in a positive electrode current collector 112 of the outermost positive electrode sheet portion 111 out of a plurality of positive electrode current collectors 112 at the corner portion 105r. The positive electrode exposed portion 112A is formed in each positive electrode current collector 112 disposed on the inner side from the outermost positive electrode sheet portion 111 out of the positive electrode current collectors 112 at the corner portion 105r.

As illustrated in FIG. 4, the inner positive electrode active material layer 114 provided at a position adjacent to the positive electrode exposed portion 112A in a circumferential direction of the wounded assembly includes a facing surface 114a that faces the positive electrode exposed portion 112A with a gap.

The negative electrode current collector 122 at the corner portion 105r includes only a negative electrode covered portion 122B covered with the inner negative electrode active material layer 124 and the outer negative electrode active material layer 126.

Next, with reference to FIG. 5, a method of manufacturing the electrode assembly 105 is described. This manufacturing method includes a positive electrode sheet preparation step, a negative electrode sheet preparation step, and a winding step.

In the positive electrode sheet preparation step, the above-mentioned positive electrode sheet 110 is prepared. As illustrated in FIG. 5, the positive electrode sheet 110 in a developed state includes the positive electrode current collector 112 formed in a band shape, the inner positive electrode active material layer 114 provided intermittently on a surface on one side of the positive electrode current collector 112 along the longitudinal direction of the positive electrode current collector 112, and the outer positive electrode active material layer 116 provided intermittently on a surface on the other side of the positive electrode current collector 112 along the longitudinal direction of the positive electrode current collector 112. The inner positive electrode active material layer 114 and the outer positive electrode active material layer 116 are formed at positions that provide an overlap in a thickness direction. In the positive electrode sheet preparation step, the inner positive electrode active material layer 114 and the outer positive electrode active material layer 116 are provided by intermittent coating on the respective surfaces of the positive electrode current collector 112 so as to form the positive electrode exposed portion 112A in the positive electrode current collector 112. It is to be noted that, in FIG. 5, the inner positive electrode active material layer 114 is indicated by dots, and a part in which the positive electrode covered portion 112B is to be formed (a part to be bent in the winding step) is indicated by the long dashed short dashed line.

In the negative electrode sheet preparation step, the above-mentioned negative electrode sheet 120 is prepared. As illustrated in FIG. 5, the negative electrode sheet 120 in a developed state includes the negative electrode current collector 122 formed in a band shape, the inner negative electrode active material layer 124 provided continuously on a surface on one side of the negative electrode current collector 122 along the longitudinal direction of the negative electrode current collector 122, and the outer negative electrode active material layer 126 provided continuously on a surface on the other side of the negative electrode current collector 122 along the longitudinal direction of the negative electrode current collector 122. The inner negative electrode active material layer 124 and the outer negative electrode active material layer 126 are formed at positions that provide an overlap in the thickness direction. In the negative electrode sheet preparation step, the inner negative electrode active material layer 124 and the outer negative electrode active material layer 126 are provided by continuous coating on the respective surfaces of the negative electrode current collector 122 so as to form the negative electrode covered portion 122B in the negative electrode current collector 122. It is to be noted that, in FIG. 5, the inner negative electrode active material layer 124 is indicated by hatching, and a part in which the negative electrode covered portion 122B is to be formed (a part to be bent in the winding step) is indicated by the long dashed short dashed line.

In the winding step, the positive electrode sheet 110 and the negative electrode sheet 120 are wound through intermediation of the separator 130. Specifically, in this step, the positive electrode sheet 110, the negative electrode sheet 120, and the separator 130 are wound so that the positive electrode exposed portion 112A is positioned at each of the four corner portions 105r at the time of viewing the wound assembly in the axial direction of the wound assembly.

As described above, in the electricity storage cell 1 of this embodiment, the energy density is improved by accommodating the electrode assembly 105 including the four corner portions 105r in the cell case 300 formed in a cuboid shape. Further, the positive electrode current collector 112 at the corner portion 105r includes the positive electrode exposed portion 112A and the negative electrode current collector 122 at the corner portion 105r includes only the negative electrode covered portion 122B, and hence the precipitation of lithium ions onto the negative electrode sheet 120 at the time of charging is reduced.

The above-mentioned exemplary embodiment is understood as a specific example of the following aspects by a person skilled in the art.

### Aspect 1

An electricity storage cell including:
an electrode assembly configured of a wound assembly including a positive electrode sheet and a negative electrode sheet that are wound through intermediation of a separator; and
a cell case that accommodates the electrode assembly, in which:
   the positive electrode sheet includes:
      a positive electrode current collector;
      an inner positive electrode active material layer provided on an inner surface of the positive electrode current collector in a radial direction of the wound assembly; and
      an outer positive electrode active material layer provided on an outer surface of the positive electrode current collector in the radial direction;
   the negative electrode sheet includes:
      a negative electrode current collector;
      an inner negative electrode active material layer provided on an inner surface of the negative electrode current collector in the radial direction; and
      an outer negative electrode active material layer provided on an outer surface of the negative electrode current collector in the radial direction;
   the cell case is formed in a cuboid shape;
   the electrode assembly includes four corner portions at the time of viewing the electrode assembly in an axial direction of the wound assembly;
   the positive electrode current collector at each of the corner portions includes a positive electrode exposed portion not provided with the inner positive electrode active material layer and the outer positive electrode active material layer; and
   the negative electrode current collector at each of the corner portions includes only a negative electrode covered portion covered with the inner negative electrode active material layer and the outer negative electrode active material layer.

In this electricity storage cell, the energy density is improved with the electrode assembly including the four corner portions. Further, the positive electrode current collector at the corner portion includes the positive electrode exposed portion and the negative electrode current collector at the corner portion includes only the negative electrode covered portion, and hence the precipitation of lithium ions onto the negative electrode sheet at the time of charging is reduced.

### Aspect 2

The electricity storage cell according to aspect 1, in which:
the positive electrode sheet includes an outermost positive electrode sheet portion disposed on an outermost periphery of the wound assembly; and
the positive electrode current collector in the outermost positive electrode sheet portion at each of the corner portions includes a positive electrode covered portion covered with the inner positive electrode active material layer and the outer positive electrode active material layer.

In this aspect, the positive electrode current collector in the outermost positive electrode sheet portion having a relatively large radius of curvature includes each positive electrode active material layer, and hence the capacity can be increased while each positive electrode active material layer at the corner portion is prevented from being cracked or the like.

### Aspect 3

The electricity storage cell according to aspect 1 or 2, in which the inner positive electrode active material layer provided at a position adjacent to the positive electrode exposed portion in a circumferential direction of the wound assembly includes a facing surface that faces the positive electrode exposed portion with a gap.

### Aspect 4

A method of manufacturing an electrode assembly in an electricity storage cell, the method including:
preparing a positive electrode sheet including a positive electrode current collector, an inner positive electrode active material layer provided on a surface on one side of the positive electrode current collector, and an outer positive electrode active material layer provided on a surface on the other side of the positive electrode current collector;
preparing a negative electrode sheet including a negative electrode current collector, an inner negative electrode active material layer provided on a surface on one side of the negative electrode current collector, and an outer negative electrode active material layer provided on a surface on the other side of the negative electrode current collector; and
winding the positive electrode sheet and the negative electrode sheet through intermediation of a separator to form the electrode assembly configured of a wound assembly, in which:
   the preparing of the positive electrode sheet includes providing the inner positive electrode active material layer and the outer positive electrode active material layer by intermittent coating on the surface on the one side and the surface on the other side of the positive electrode current collector so as to form a positive electrode exposed portion not provided with the inner positive electrode active material layer and the outer positive electrode active material layer;
   the preparing of the negative electrode sheet includes providing the inner negative electrode active material layer and the outer negative electrode active material layer by continuous coating on the surface on the one side and the surface on the other side of the negative electrode current collector; and
   the winding includes winding the positive electrode sheet, the negative electrode sheet, and the separator so as to position the positive electrode exposed portion at each of four corners at the time of viewing the wound assembly in an axial direction of the wound assembly.

It is to be noted that the embodiment disclosed herein is illustrative and not restrictive in all respects. The scope of the present disclosure is defined by not the description of the above embodiment but the appended claims. The scope of the present disclosure is intended to encompass all modifications within the meaning and the scope of the appended claims and equivalents thereof.

What is claimed is:

1. An electricity storage cell comprising:
an electrode assembly configured of a wound assembly including a positive electrode sheet and a negative electrode sheet that are wound through intermediation of a separator; and
a cell case that accommodates the electrode assembly, wherein:
the positive electrode sheet includes:
a positive electrode current collector;
an inner positive electrode active material layer provided on an inner surface of the positive electrode current collector in a radial direction of the wound assembly; and
an outer positive electrode active material layer provided on an outer surface of the positive electrode current collector in the radial direction;
the negative electrode sheet includes:
a negative electrode current collector;
an inner negative electrode active material layer provided on an inner surface of the negative electrode current collector in the radial direction; and
an outer negative electrode active material layer provided on an outer surface of the negative electrode current collector in the radial direction;
the cell case is formed in a cuboid shape;
the electrode assembly includes four corner portions at the time of viewing the electrode assembly in an axial direction of the wound assembly;
the positive electrode current collector at each of the corner portions includes a positive electrode exposed portion not provided with the inner positive electrode active material layer and the outer positive electrode active material layer; and
the negative electrode current collector at each of the corner portions includes only a negative electrode covered portion covered with the inner negative electrode active material layer and the outer negative electrode active material layer.

2. The electricity storage cell according to claim 1, wherein:
the positive electrode sheet includes an outermost positive electrode sheet portion disposed on an outermost periphery of the wound assembly; and
the positive electrode current collector in the outermost positive electrode sheet portion at each of the corner portions includes a positive electrode covered portion covered with the inner positive electrode active material layer and the outer positive electrode active material layer.

3. The electricity storage cell according to claim 1, wherein the inner positive electrode active material layer provided at a position adjacent to the positive electrode exposed portion in a circumferential direction of the wound assembly includes a facing surface that faces the positive electrode exposed portion with a gap.

4. A method of manufacturing an electrode assembly in an electricity storage cell, the method comprising:
preparing a positive electrode sheet including a positive electrode current collector, an inner positive electrode active material layer provided on a surface on one side of the positive electrode current collector, and an outer positive electrode active material layer provided on a surface on the other side of the positive electrode current collector;
preparing a negative electrode sheet including a negative electrode current collector, an inner negative electrode active material layer provided on a surface on one side of the negative electrode current collector, and an outer negative electrode active material layer provided on a surface on the other side of the negative electrode current collector; and
winding the positive electrode sheet and the negative electrode sheet through intermediation of a separator to form the electrode assembly configured of a wound assembly, wherein:
the preparing of the positive electrode sheet includes providing the inner positive electrode active material layer and the outer positive electrode active material layer by intermittent coating on the surface on the one side and the surface on the other side of the positive electrode current collector so as to form a positive electrode exposed portion not provided with the inner positive electrode active material layer and the outer positive electrode active material layer;
the preparing of the negative electrode sheet includes providing the inner negative electrode active material layer and the outer negative electrode active material layer by continuous coating on the surface on the one side and the surface on the other side of the negative electrode current collector; and
the winding includes winding the positive electrode sheet, the negative electrode sheet, and the separator so as to position the positive electrode exposed portion at each of four comers at the time of viewing the wound assembly in an axial direction of the wound assembly.
